(19) United States
(12) Patent Application Publication
(10) Pub. No.: US 2006/0004839 A1
(43) Pub. Date: Jan. 5, 2006

(54) Method and system for data processing with data replication for the same

(76) Inventors: Jun Nagasawa, Yokohama (JP); Nobuo Kawamura, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/932,117

(22) Filed: Sep. 2, 2004

(30) Foreign Application Priority Data
Jun. 16, 2004 (JP) 2004-177747

(51) Int. Cl. G06F 17/00

(52) U.S. Cl. 707/102

(57) ABSTRACT

A data processing method in a database management system having a main database and a sub database, for generating the sub database by utilizing log information generated by a data operation of the main database utilizing a transaction processing. When a checkpoint as a recovery timing of the database in the transaction processing is detected, the data operation based on the log information generated before the checkpoint is processed for the sub database. Replication from the main database to the sub database is accomplished in this way. Whenever the checkpoint is detected, a data operation is executed for the sub database based on the log information generated from a checkpoint immediately before the checkpoint detected to the checkpoint detected and replication from the main database to the sub database is accomplished.

### INCORPORATION BY REFERENCE

The present application claims priority from Japanese application JP2004-177747 filed on Jun. 16, 2004, the content of which is hereby incorporated by reference into this application.

### BACKGROUND OF THE INVENTION

This invention relates to a data processing technology for generating replication of data.

In a conventional large-quantity database system, a periodical backup operation is necessary. Because this processing involves a collective access to the database used in an online service, influences on the online business are great and this problem hinders the provision of continuous 24-hour services. Another problem is that a backup acquisition time becomes enormous with the scale of the database. As means for solving the problems, differential backup that acquires backup for only a portion updated from the previous backup acquisition point has been provided. Such a differential backup technology is disclosed in JP-A-07-160559.

A method having replication of a database of an online business by utilizing an SAN (Storage Area Network) construction that has now become wide spread, that is, a construction in which a plurality of external storage devices such as magnetic disk devices is organically combined through a dedicated high-speed network, is known. In this construction, the external storage device provides a function of copying at a high speed an arbitrary logical volume to a plurality of logical volumes, a function of conducting multi-write of data by using an arbitrary logical volume as a main volume and a plurality of other logical volumes as sub volumes and a function of cutting off the logical volume under the multi-write state at an arbitrary point and making it possible to gain access to the main and sub volumes as independent volume.

### SUMMARY OF THE INVENTION

When any fault occurs in a database in a conventional database system, the fault is recovered to the state before the occurrence of the fault by using backup of the database and an updating log. In a system that handles a large-quantity database and has a high updating load, however, an enormous time is necessary also for creating backup. It is therefore difficult to frequently create backup. Differential backup has been provided as means for solving this problem but it is only the case of the business in which an updating range of data is limited that this means is effective.

The longer becomes the time lapsed from the creation point of backup of the database, the greater becomes the quantity of the updating log necessary for recovering the database and the longer becomes the fault recovery time, too.

In a system that executes multi-write of a plurality of databases in the SAN construction, the function of the external storage device cannot detect the logical fault of the database. For this reason, the state of the database fault is inevitably reflected on the replication database. To use the replication database for the purpose of backup, the disks must be periodically cut off. To again establish synchronization with the state of the database, copy of the entire disks must be made. Because the copying time is also very long, the copying operation cannot be executed so frequently.

The invention aims at reducing the recovery time at the occurrence of the database fault without increasing the opportunity of acquiring backup and cutting-off of the replication database.

To solve the problem, information of the updating log is reflected on the replication database created with a certain arbitrary time as the reference in the interlocking arrangement with a checkpoint of the database. In consequence, a replication database more approximate to the present database state than the point of creation of the replication database is generated without creating again the replication database.

The invention can minimize the quantity of the updating log necessary for the recovery of the database and can execute within a short time the recovery operation of the database at the time of the fault.

Other objects, features and advantages of the invention will become apparent from the following description of the embodiments of the invention taken in conjunction with the accompanying drawings.

### BRIEF DESCRIPTION OF THE DRAWINGS

FIG. 1 shows a system construction of a first embodiment;

FIG. 2 shows a state transition of a database during a normal operation of the first embodiment;

FIG. 3 shows a state transition of the database during the occurrence of a fault of the first embodiment;

FIG. 4 shows a construction of an updating log file of the first embodiment;

FIG. 5 shows a checkpoint management table of the first embodiment;

FIG. 6 shows a construction of a database of the first embodiment;

FIG. 7 shows a user operation procedure of the first embodiment;

FIG. 8 shows an outline of a processing of a database management system of the first embodiment;

FIG. 9 shows a replication database catch-up processing of the first embodiment;

FIG. 10 shows an object checkpoint acquisition processing of the first embodiment;

FIG. 11 shows a catch-up updating log acquisition processing of the first embodiment;

FIG. 12 shows a catch-up updating log reflection processing of the first embodiment;

FIG. 13 shows a system construction of a second embodiment;

FIG. 14 shows a construction of a DB-disk block conversion table of the second embodiment;

FIG. 15 shows an outline of a replication database catch-up processing of the second embodiment;

FIG. 16 shows a system construction of a third embodiment; and

FIG. 17 shows a construction of a disk updating log of the third embodiment.

### DESCRIPTION OF THE EMBODIMENTS

Embodiments of the invention will be hereinafter explained in detail with reference to the accompanying drawings.

### Embodiment 1

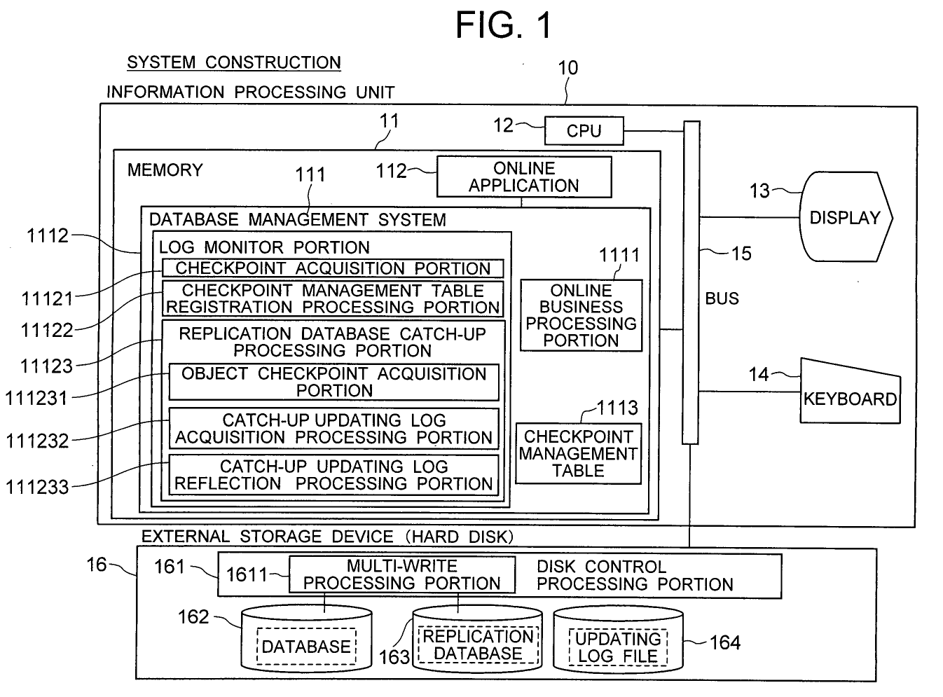

FIG. 1 shows a construction of an information processing apparatus according to the first embodiment of the invention. This embodiment is accomplished by the information processing apparatus 10 and an external storage device 16 that are connected through a bus 15. The information processing apparatus 10 includes a CPU 12, a memory 11, a display 13 and a keyboard 14. An online application 112 on the memory 11 is used for gaining access to a database 162 on the external storage device 16 through a database management system 111. An updating content of the database 162 is recorded, too, as updating history information to an updating log file 164 and can be reflected on a replication database 163 by a multi-write mechanism 1611. The multi-write mechanism 1611 can release multi-write (also referred to as “mirroring”) at an arbitrary timing and makes the replication database 163 also readable and writable as a database independent of the database 162 through the database management system 111. The database management system 111 includes an online business processing portion 1111 for executing a processing request of the online application 112 and a log monitor processing portion 1112 for monitoring the content of the updating log file 164. The log monitor processing portion 1112 includes a checkpoint acquisition processing portion 11121 for acquiring a checkpoint of a database, a checkpoint management table registration processing portion 11122 for registering information to a checkpoint management table 1113 and a replication database catch-up processing portion 11123 for bringing the state of the replication database 163 into conformity with the state of the database 162 in the interlocking arrangement with the checkpoint. The replication database catch-up processing portion 11123 includes an object checkpoint acquisition processing portion 111231, a catch-up updating log acquisition portion 111232 and a catch-up updating log reflection processing portion 111233. Each of these processing portions and systems can be accomplished by programs, objects, processes and threads and can also be accomplished by hardware. The online application 112 is hereby explained as the business program by way of example but is not particularly limited to the online programs and can be applied to programs in general for gaining access to the database. This also holds true of other embodiments. The information processing apparatus 10 and the external storage device 16 are hereby illustrated as separate apparatuses but they may be accomplished by the same apparatus.

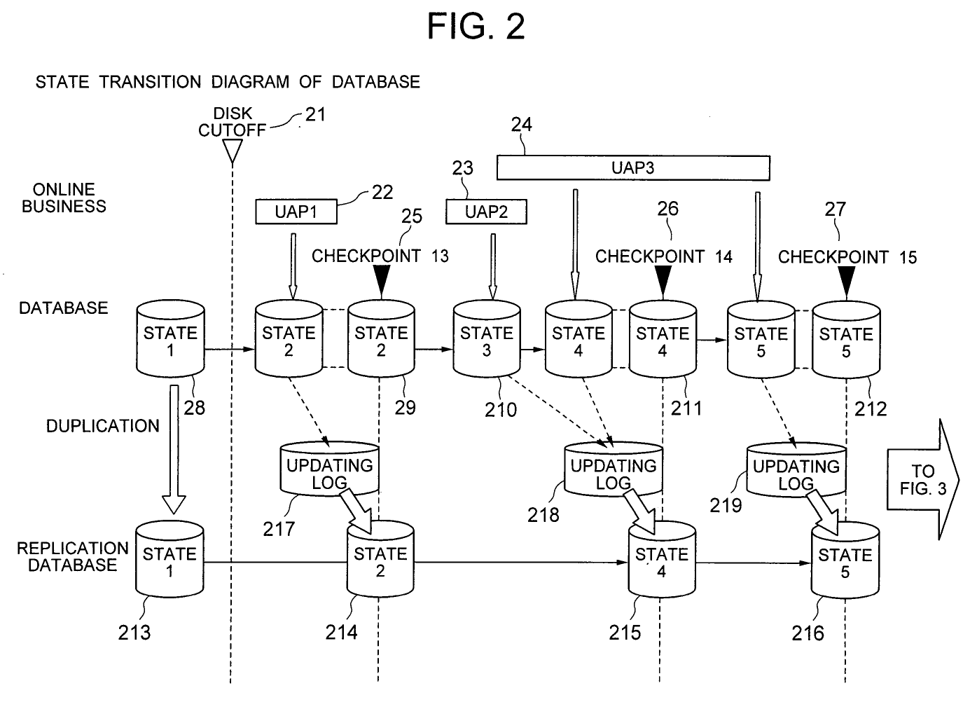

FIG. 2 shows an outline of state transition of the database 162 and the replication database 163 during the normal operation of this embodiment. In the database management system 111 of this embodiment, the multi-write processing portion 1611 reflects the database 28 on the replication database 213 (State 1). Here, the replication database 213 is used as a backup file by generating a disk cutoff request 21 to the external storage device 16. The database 29 is updated by the database access processing of the online application 22 (State 2) after cutoff of the disk. The updating history information of the database is outputted in this instance to the updating log 217. Next, the database management system 111 executes the checkpoint acquisition processing 25 as well as the replication database catch-up processing, updates the replication database 214 by using the updating log 217 and brings the state into conformity with the state of the database 29 (State 2). The database management system 111 thereafter executes the checkpoint acquisition processing and the replication database catch-up processing in the same way and brings the state of the replication database into the state of the database.

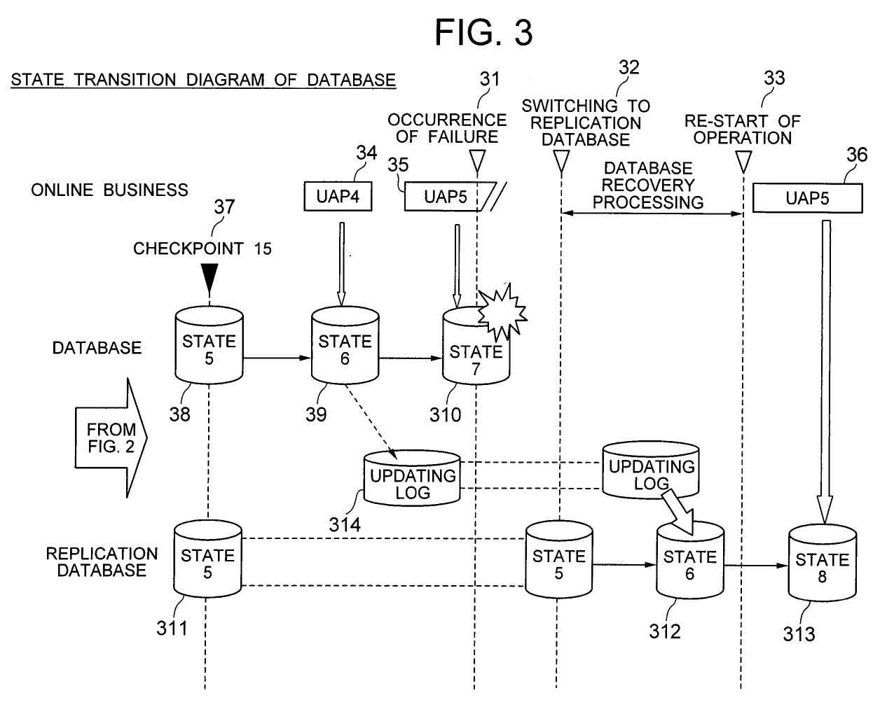

FIG. 3 shows the outline of the state transition of the database 162 and the replication database 163 at the occurrence of a fault during the operation of this embodiment. The replication database 311 is updated in match with the state of the database 38 at the point of the checkpoint 37 (State 5). As the database access processing of the online application 34 is thereafter executed, the database 39 is updated (State 6). Updating history information of the database at this time is outputted to an updating log 314. When any fault occurs in this case in the database 310 during the processing of the online application 35 (31), the operation object is switched from the database 310 to the replication database 311 (32). Next, an ordinary database restoration processing is executed by using the updating log 314 subsequent to the check point 37 and the replication database 311 is updated to the latest database state 312 (State 6). Due to this operation, the re-start of the operation of the online business is possible (33). The online application 35 that is under execution at the time of the occurrence of the fault is again executed (36) and the business is continued. This embodiment has been explained about the case where the updating history information created by the addition or updating of the database 162 is reflected on the replication database at each checkpoint. It is also possible to count a predetermined number of times of the checkpoints and to reflect the updating history information built up in the mean time on the replication database. In this embodiment, the updating history information is reflected on the replication database at the timing of each checkpoint but can be reflected on the replication database by receiving a reflection request from a database management system or from a program for gaining access to the database.

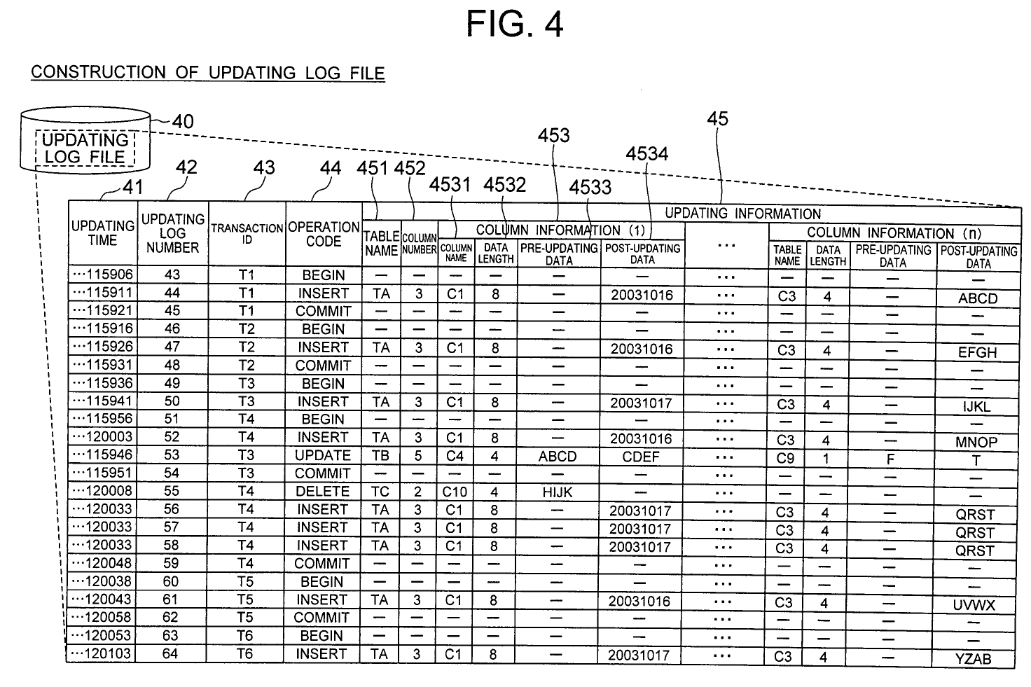

FIG. 4 shows a construction and a content of an updating log file 40 of the database access executed in accordance with the state transition diagram of FIG. 2. Records of the updating log file 40 are aligned in a time series in an individual operation unit constituting the transaction. The execution result of each operation includes an updating time 41, an updating log number 42, a transaction ID 43, an operation code 44 and updating information 45. The updating information 45 includes a table name 451, a column number 452 and column information of the column number 452. The column information 453 includes a column name 4531, a data length 4532, pre-updating data 4533 and post-updating data 4534.

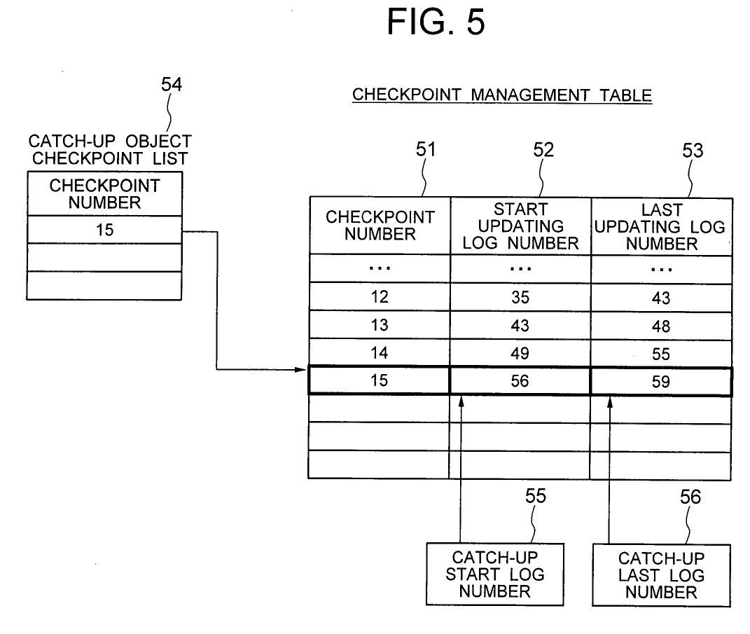

FIG. 5 shows the content of the management table of the checkpoints executed in accordance with the state transition diagram of FIG. 2. The records of the checkpoint management table are aligned in the checkpoint unit and in the time series. The checkpoint management table includes a checkpoint number 51, a start updating log number 52 representing the first updating log number at the checkpoint and a last updating log 53 representing the last log number. The catch-up object checkpoint list 54 stores the numbers of the checkpoints to be reflected on the replication database in the time series when the replication database catch-up processing is executed. The catch-up start log number 55 stores the start updating log number of the leading checkpoint in the catch-up object check point list 54. The catch-up last log number 56 stores the last updating log number of the last checkpoint in the catch-up object checkpoint list 54.

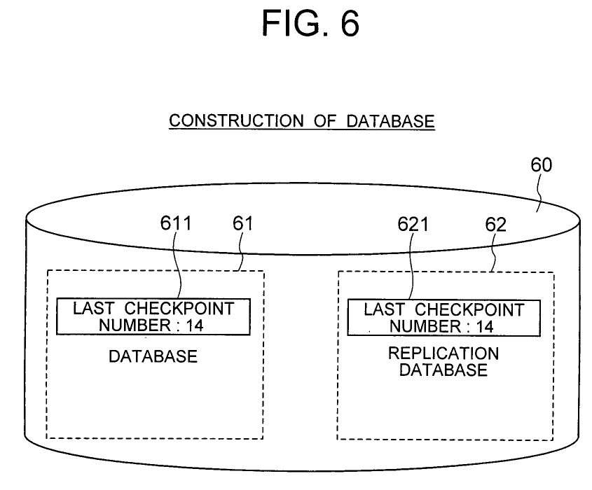

FIG. 6 shows a construction and an updating content of the database updated in accordance with the state transition diagram of FIG. 2. The external storage device 60 includes a logical volume 61 for storing the database and a logical volume 62 for storing the replication database. The logical volume 61 for storing the database stores the checkpoint number 611 that is processed last for the database. The logical volume 62 for storing the replication database stores the checkpoint number 621 processed last for the replication database.

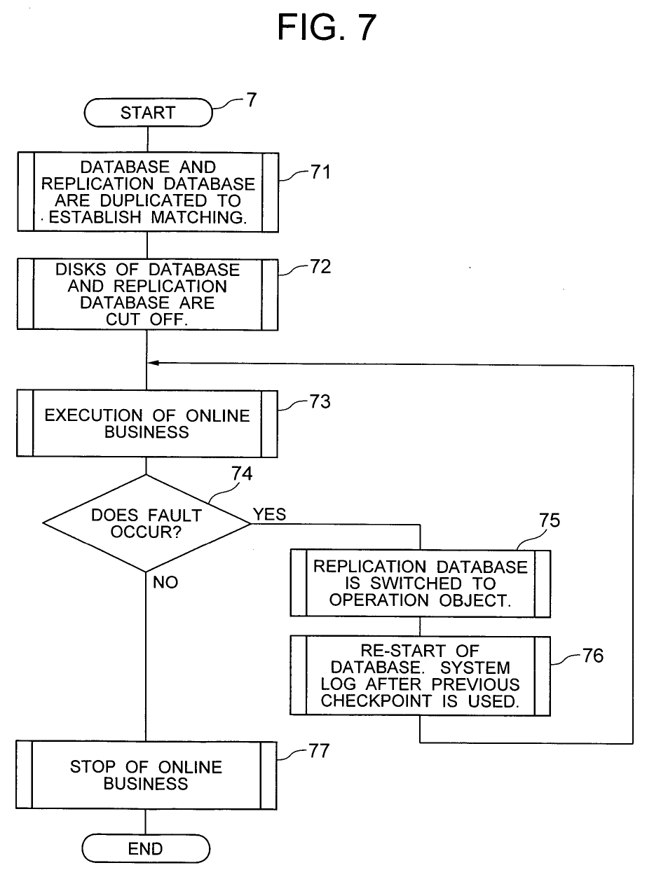

FIG. 7 shows an operation procedure of a user in this embodiment. First, the user duplicates the database and the disk of the replication database and brings their states into conformity with each other (Step 71). The disk is then cut off and the replication database is used as backup (Step 72). Next, the online business is conducted (Step 73). When any fault occurs during the execution of the business (Step 74), the operation object is switched to the replication database (Step 75) and a re-start processing of the ordinary database is conducted (Step 76). When the online business stops, the system is stopped (Step 77).

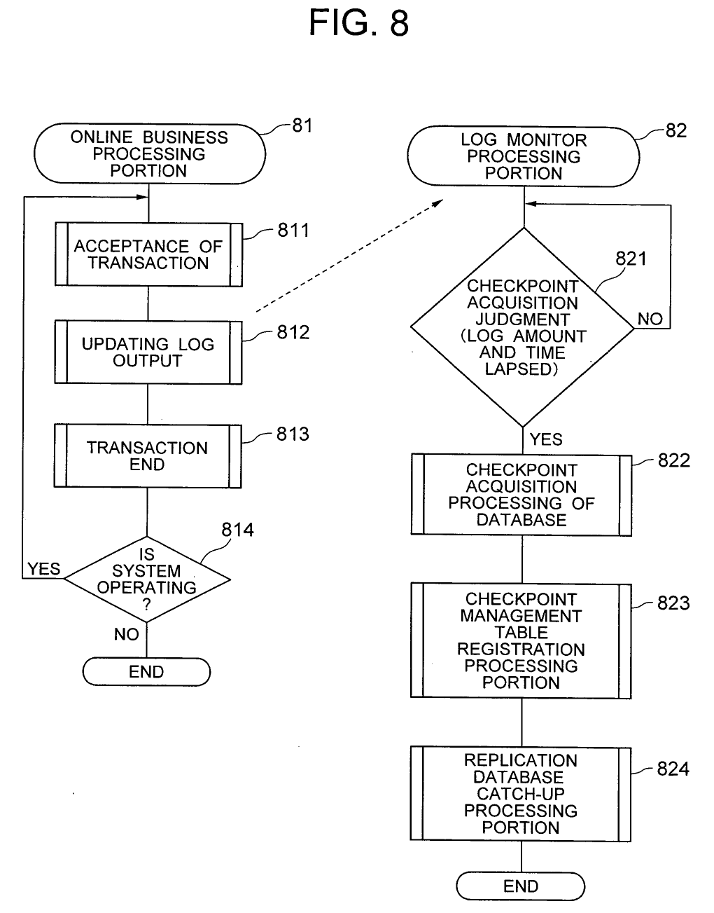

FIG. 8 shows the outline of the processing of the database management system. The online business processing portion 81 executes a transaction acceptance processing (Step 811), an updating log output processing (Step 812) and a transaction end processing (Step 813). This processing is repeated while the system is activated (Step 814). On the other hand, the log monitor processing portion 82 monitors the state of the updating log outputted from the online business processing portion 81 (Step 821) and executes a checkpoint acquisition processing in accordance with the condition such as the output quantity of the updating log and the time lapsed from the previous checkpoint processing time (Step 822). At the same time, a processing for registering checkpoint information under processing to the checkpoint management table (Step 823) and the catch-up processing of the replication database are executed (Step 824).

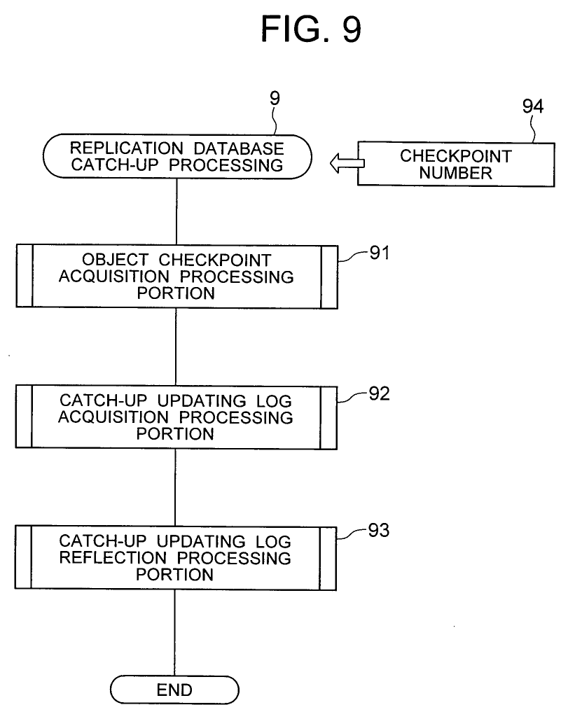

FIG. 9 shows the flow of the replication database catch-up processing. The replication database catch-up processing 9 includes the step 91 of using the number 94 of the checkpoint executed as input information and acquiring the checkpoint as the catch-up object, the step 92 of acquiring an updating log number as the catch-up object and the step 93 of reflecting the updating log as the catch-up object on the replication database.

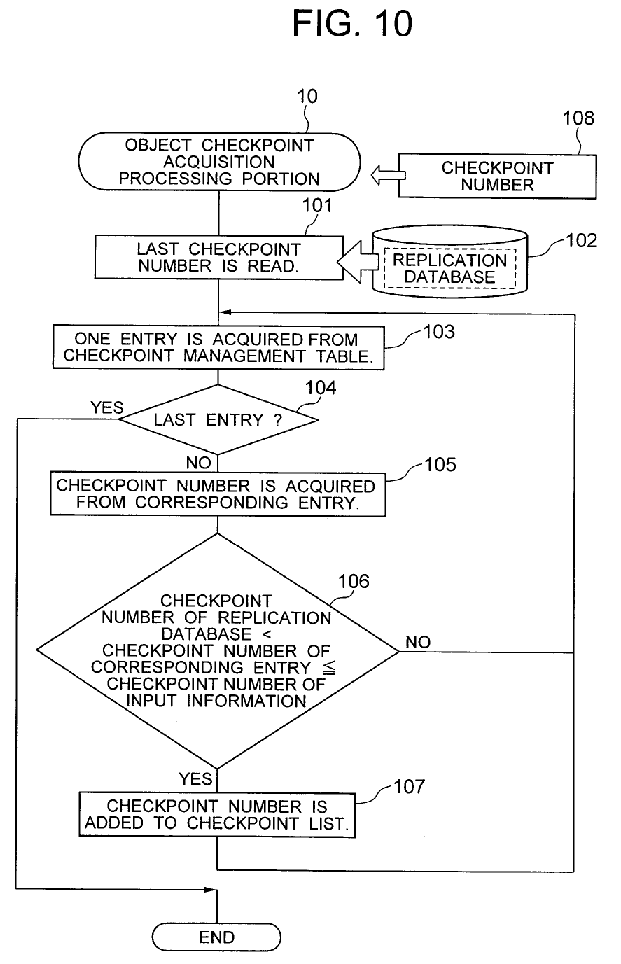

FIG. 10 shows the flow of the processing for acquiring the checkpoint number as the catch-up object. The object checkpoint acquiring processing 10 uses the number 108 of the executed checkpoint as the input information and first reads out the last checkpoint number from the replication database 102 (Step 101). Next, this acquiring processing 10 acquires one entry from the checkpoint management table (Step 103), judges whether or not the entry is the last entry (Step 104) and finishes the processing when the entry is the last entry. The object checkpoint acquiring processing then acquires the checkpoint number 51 from the entry of the checkpoint management table so acquired (Step 105), judges whether or not the checkpoint number is within the range of the checkpoint number of the replication database acquired in Step 101 and within the range of the checkpoint number 108 of the input information (Step 106) and returns to Step 103 when it is out of the ranges. When the checkpoint number is within the ranges, the checkpoint number acquired in Step 105 is added to the catch-up object checkpoint list 54 (Step 107) and the flow returns to Step 103.

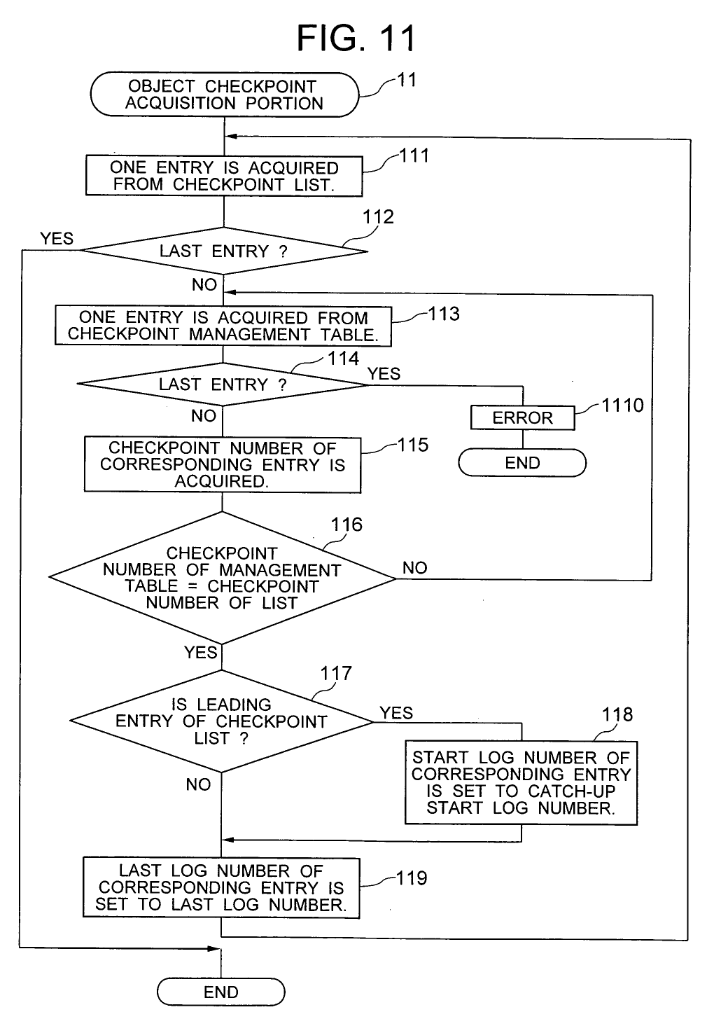

FIG. 11 shows the flow of a processing for acquiring an updating log number as the catch-up object from the catch-up object checkpoint list 54 and from the checkpoint management table. The catch-up object updating log acquiring processing 11 first acquires one entry from the catch-up object checkpoint list 54 (Step 111), judges whether or not the entry is the last entry (Step 112) and finishes the processing when the entry is the last entry. Next, the acquiring processing 11 acquires one entry from the checkpoint management table (Step 113) and judges whether or not the entry is the last entry (Step 114). Since the checkpoint number that exists is always stored in the catch-up object checkpoint list 54, an error processing is finished when the entry is the last entry (Step 1110). The checkpoint number 51 is acquired from the entry of the checkpoint management table so acquired (Step 115) and whether or not this checkpoint number is coincident with the checkpoint number of the catch-up object checkpoint list obtained in Step 111 (Step 116). When they are not coincident, the processing returns to Step 113. When they are coincident and when the entry is the leading entry of the catch-up object checkpoint list (Step 117), the start updating log number 52 of the entry obtained in Step 115 is set to the catch-up start log number 55 (Step 118). The last updating log number 53 of the entry obtained in Step 115 is set to the catch-up last log number 56 (Step 119) and the processing returns to Step 111.

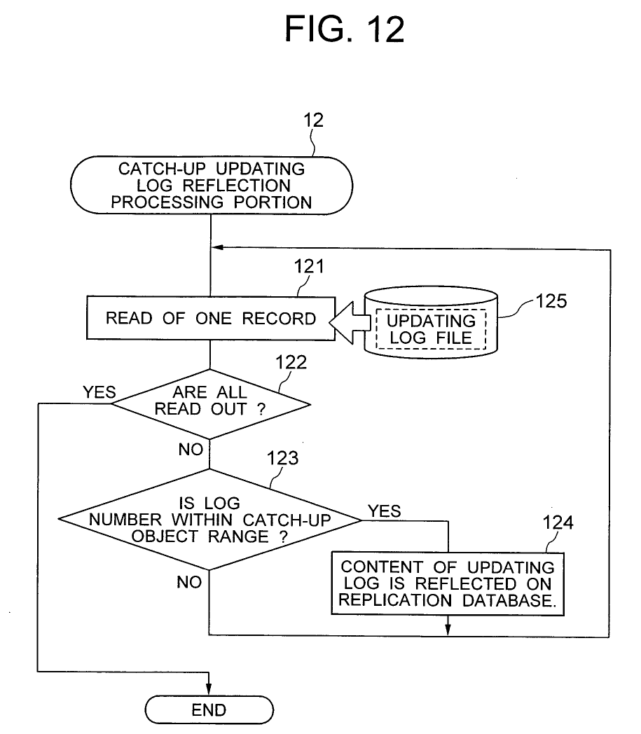

FIG. 12 shows the flow of the processing for reflecting the updating log as the catch-up object on the replication database. The catch-up updating log reflection processing portion 12 reads out one record from the updating log file 125 (Step 121). Whether or not the records are all read out is judged (Step 122) and when they are read out, the processing is finished. Whether or not the updating log number read out in Step 121 is within the catch-up object range is judged (Step 123) and the processing returns to Step 121 when the updating log number is out of this range. When the updating log number is within the range, the content of the updating log is reflected on the replication database (Step 124) and the processing returns to Step 121.

### Embodiment 2

Another embodiment in which the replication database catch-up processing is executed on the side of the external storage device will be hereinafter explained.

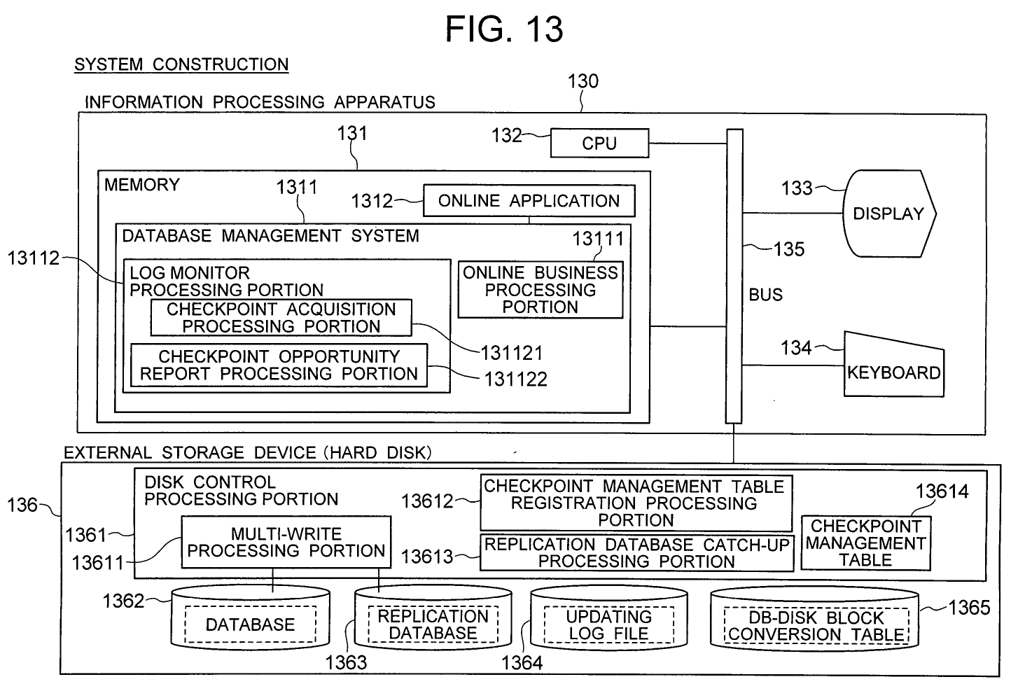

FIG. 13 shows a construction of an information processing apparatus according to the second embodiment of the invention. This embodiment is accomplished by an information processing apparatus 130 and an external storage device 136 that are connected to each other through a bus 130. The information processing apparatus 130 includes a CPU 132, a memory 131, a display 133 and a keyboard 134. An online application 1312 on the memory 131 is for gaining access to a database 1362 on the external storage device 136 through a database management system 1311. An updating content of the database 1362 is recorded as updating history information to an updating log file 1364 and can be reflected on the real time basis on a replication database 1363 by a multi-write processing portion 13611 on a disk control processing portion 1361. The multi-write processing portion 13611 can release multi-write at an arbitrary timing and can make the replication database 1363 readable and writable as a database independent of the database 1362 through the database management system 1311. The database management system 1311 includes an online business processing portion 13111 for executing a processing request of the online application 1312 and a log monitor processing portion 13112 for monitoring the content of an updating log file 1364. The log monitor processing portion 13112 includes a checkpoint acquisition processing portion 131121 for acquiring a checkpoint of a database and a checkpoint opportunity report processing portion 131122 for reporting a checkpoint opportunity to the disk control processing portion 1361 of the external storage device 136. The disk control processing portion 1361 includes a checkpoint management table registration processing portion 13612 for registering information to a checkpoint management table 13614 and a replication database catch-up processing portion 13613 and reflects the updating content of the updating log file 1364 on the replication database 1363. The replication database catch-up processing portion 13613 associates the logical positions of the database 1362, the replication database 1363 and the updating log file 1364 with the blocks on the disk by referring to a DB-disk conversion table 1365.

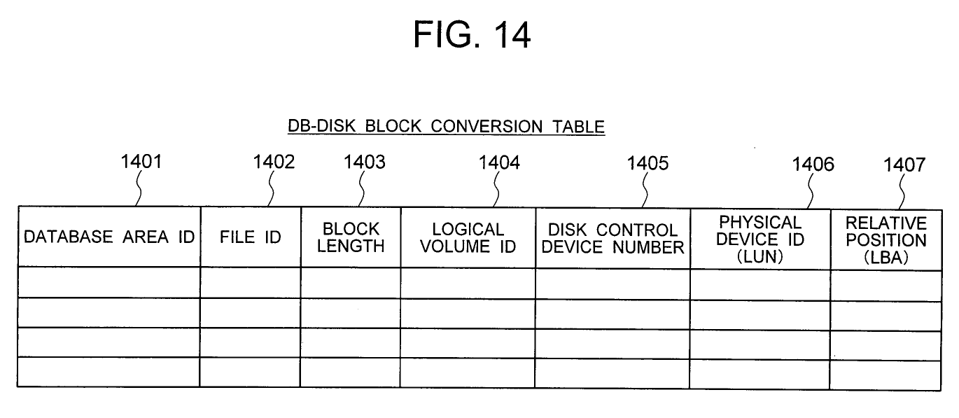

FIG. 14 shows a construction of the DB-disk block conversion table. As shown in FIG. 14, the DB-disk block conversion table 1365 includes a database area ID 1401 for identifying a database area 1362, a file ID 1402 for representing a file sequence number when the database area identified by the database ID is constituted by a plurality of files, a block length 1403 for representing the length of each block constituting the database area, a logical volume ID 1404 for identifying logical volumes securing constituent files of the database area, a disk control device number 1405 as the number for identifying the external storage device to which the logical volume identified by the logical volume ID is mapped, a physical device ID 1406 as information for identifying a drive number of a magnetic disk device to which the logical volume is mapped and a relative position 1407 for representing a relative position of the file on the magnetic disk device identified by the physical device ID.

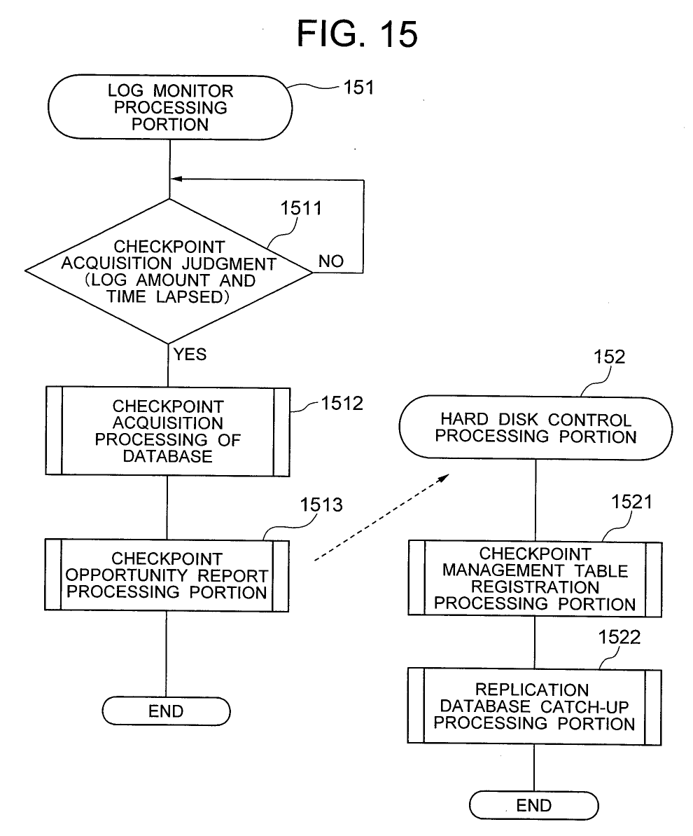

FIG. 15 shows the outline of the replication database catch-up processing in the second embodiment. A log monitor processing portion 151 monitors the state of the updating log (Step 1511) and executes a checkpoint acquisition processing of the database in accordance with the condition such as the output quantity of the updating log and the time lapsed from the previous checkpoint processing (Step 1512). At the same time, the log monitor processing portion 151 executes the report processing of the checkpoint opportunity (Step 1513). On the other hand, a hard disk control processing portion 152 executes a checkpoint management table registration processing (Step 152) and a replication database catch-up processing (Step 1522) at the point at which the checkpoint opportunity is reported.

### Embodiment 3

An embodiment in which the replication database catch-up processing is executed by using the external storage device but not the updating log of the database in the second embodiment of the invention will be explained.

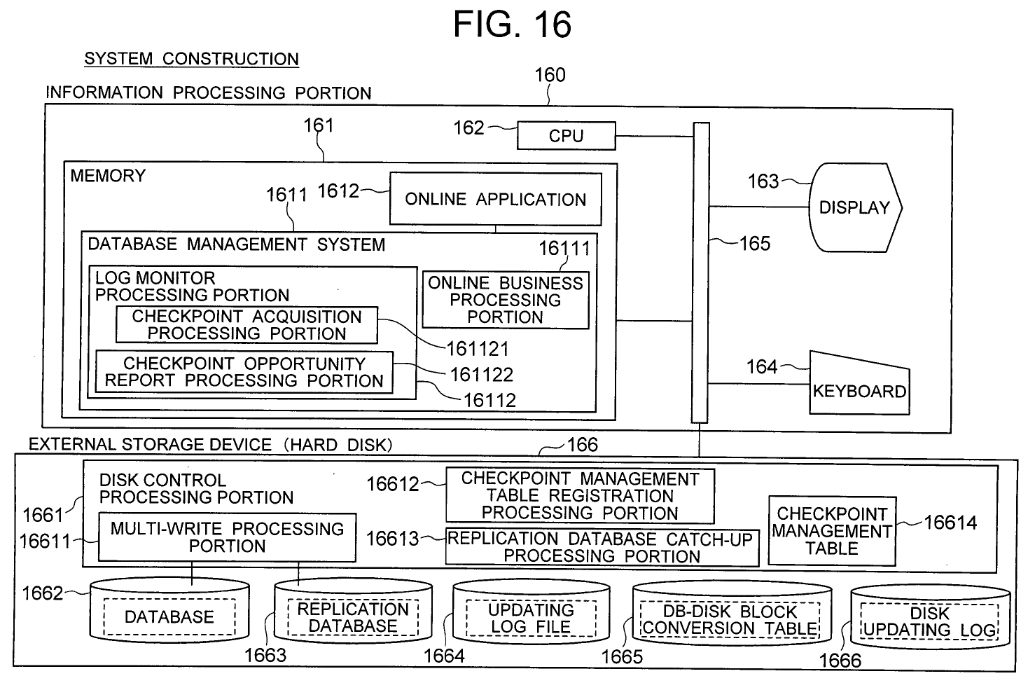

FIG. 16 shows a construction of an information processing apparatus according to the third embodiment of the invention. This embodiment is accomplished by an information processing apparatus 160 and an external storage device 166 that are connected to each other through a bus 165. The information processing apparatus 160 includes a CPU 162, a memory 161, a display 163 and a keyboard 164. An online application 1612 on the memory 161 is for gaining access to a database 1662 on the external storage device 166 through a database management system 1611. An updating content of the database 1662 is recorded as updating history information to an updating log file 1664 and can be reflected on the real time basis on a replication database 1663 by a multi-write processing portion 16611 on a disk control processing portion 1661. The multi-write processing portion 16611 can release multi-write at an arbitrary timing and can make the replication database 1663 readable and writable as a database independent of the database 1662 through the database management system 1611. Incidentally, the updating contents of the disk of the external storage device are all recorded to the disk updating log 1666.

The database management system 1611 includes an online business processing portion 16111 for executing a processing request of the online application 1612 and a log monitor processing portion 16112 for monitoring the content of an updating log file 1664. The log monitor processing portion 16112 includes a checkpoint acquisition processing portion 161121 for acquiring a checkpoint of a database and a checkpoint opportunity report processing portion 161122 for reporting a checkpoint opportunity to the disk control processing portion 1661 of the external storage device 166. The disk control processing portion 1661 includes a checkpoint management table registration processing portion 16612 for registering information to a checkpoint management table 16614 and a replication database catch-up processing portion 16613. The checkpoint management table registration portion 16612 registers a checkpoint number under processing and a corresponding log number of the disk updating log 1666 to the checkpoint management table 16614. The replication database catch-up processing portion 16613 associates the logical positions of the database 1662 and the replication database 1663 with the blocks on the disk by referring to a DB-disk conversion table 1665, and reflects the updating content relating to the database 1662 on the replication database 1663 from the log numbers of the disk updating logs 1666 registered to the checkpoint management table 16614. In this way, it becomes possible to extract the updating log information outputted between the checkpoint and the next checkpoint and to reflect the updating content on the replication database 1663 by using the updating log information extracted.

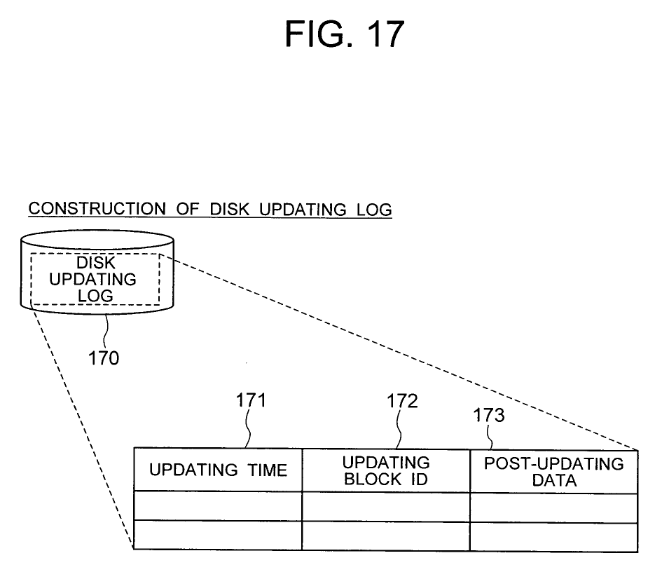

FIG. 17 shows the construction of the disk updating log. The disk updating log 170 includes an updating time 171 at which updating is made, a block ID 172 representing the block on the updated disk and post-updating data 173 representing the data after updating.

It should be further understood by those skilled in the art that although the foregoing description has been made on embodiments of the invention, the invention is not limited thereto and various changes and modifications may be made without departing from the spirit of the invention and the scope of the appended claims.

1. A data processing method in a database management system having a main database and a sub database, for generating said sub database by utilizing log information generated by a data operation of said main database utilizing a transaction processing, comprising the steps of:
detecting a checkpoint as a recovery timing of the database in said transaction processing; and
processing for said sub database a data operation based on said log information generated before said checkpoint, thereby to accomplish replication from said main database to said sub database.

2. The data processing method according to claim 1, further comprising the step of:
whenever a checkpoint is detected, processing for said sub database the data operation based on said log information generated from a checkpoint immediately before said checkpoint thus detected to said checkpoint thus detected, thereby to accomplish replication from said main database to said sub database.

3. A data processing method in a storage device storing a main database and a sub database, for generating said sub database by utilizing log information generated by a data operation of said main database utilizing a transaction processing, comprising the steps of:
receiving a timing of a checkpoint as a recovery timing of the database in said transaction processing; and
processing for said sub database, according to reception of a checkpoint, the data operation based on said log information generated from a checkpoint immediately before said checkpoint thus received to said checkpoint thus received, thereby to accomplish replication from said main database to said sub database.

4. A data processing method in a storage device storing a main database and a sub database, for generating said sub database by utilizing log information generated by a data operation of said main database, comprising the steps of:
receiving a reflection timing for reflecting said main data on said sub data; and
processing for said sub database, according to reception of a reflection timing, a data operation based on said log information generated from a reflection timing immediately before said reflection timing thus received to said reflection timing thus received, thereby to accomplish replication from said main database to said sub database.

5. A database management system having a main database and a sub database, for generating said sub database by utilizing log information generated by a data operation of said main database utilizing a transaction processing, comprising:
a unit for detecting a timing of a checkpoint as a recovery timing of the database in said transaction processing; and
a unit for executing for said sub database, upon detection of a checkpoint, a data operation based on said log information generated from a checkpoint immediately before said checkpoint thus detected to said checkpoint thus detected, thereby to accomplish replication from said main database to said sub database.

6. A storage device storing a main database and a sub database, for generating said sub database by utilizing log information generated by a data operation of said main database utilizing a transaction processing, comprising:
a unit for receiving a timing of a checkpoint as a recovery timing of the database in said transaction processing; and
a unit for executing for said sub database, according to reception of a checkpoint, a data operation based on said log information generated from a checkpoint immediately before said checkpoint thus received to said checkpoint thus received, thereby to accomplish replication from said main database to said sub database.

7. A storage device storing a main database and a sub database, for generating said sub database by utilizing log information generated by a data operation of said main database, comprising:
a unit for receiving a reflection timing for reflecting said main data on said sub data; and
a unit for executing for said sub database, according to reception of a checkpoint, a data operation based on said log information generated from a checkpoint immediately before said checkpoint thus received to said checkpoint thus received, thereby to accomplish replication from said main database to said sub database.

8. A data processing program having a main database and a sub database, for generating said sub database by utilizing log information generated by a data operation of said main database utilizing a transaction processing, comprising the steps of:
detecting a timing of a checkpoint as a recovery timing of the database in said transaction processing; and
executing for said sub database, upon detection of a checkpoint, a data operation based on said log information generated before said checkpoint thus detected, thereby to accomplish replication from said main database to said sub database.

9. A data processing program for operating a storage device having a main database and a sub database, said storage device being used for generating said sub database by utilizing log information generated by a data operation of said main database utilizing a transaction processing, said data processing program comprising the steps of:
receiving a timing of a checkpoint as a recovery timing of the database in said transaction processing; and
executing for said sub database, according to reception of a checkpoint, a data operation based on said log information generated before said checkpoint thus received, thereby to accomplish replication from said main database to said sub database.

10. A data processing program for operating a storage device having a main database and a sub database, said storage device being used for generating said sub database by utilizing log information generated by a data operation of said main database utilizing a transaction processing, said data processing program comprising the steps of:
receiving a reflection timing for reflecting said main data on said sub data; and
executing for said sub database, according to reception of a reflection timing, a data operation based on said log information generated from a reflection timing immediately before said reflection timing thus received to said reflection timing thus received, thereby to accomplish replication from said main database to said sub database.
